(19) United States
(12) Patent Application Publication
(10) Pub. No.: US 2018/0023742 A1
(43) Pub. Date: Jan. 25, 2018

(54) Connectors For Sleeved Pipe Couplings

(71) Applicant: Acorn Intellectual Properties Limited, Loddon, Norwich (GB)

(72) Inventors: Alexander Wood, Jersey, St. Helier (GB); Jonathan Clackett, Jersey, St. Helier (GB)

(21) Appl. No.: 15/546,564

(22) PCT Filed: Jan. 28, 2016
(86) PCT No.: PCT/GB2016/050181

§ 371 Date: Jul. 26, 2017

(30) Foreign Application Priority Data
Jan. 28, 2015 (GB) 1501440.0
Jun. 5, 2015 (GB) 1509744.7

(51) Int. Cl. F16L 37/14

(52) U.S. Cl. CPC F16L 37/14

(57) ABSTRACT

This invention relates to a connector (10) comprising an elongate main body (12) comprising a plurality of sub-units (14) interconnected by a support wire (30) located radially outwardly, in use, of the sub-units (14), wherein the sub-units (14) are shaped such that the connector can be bent to form a loop having an at least part-circular interior (24) or exterior (20) surface. The connector is suitable for use in a sleeved pipe coupling in which the connector (10) is slidably insertable into a channel formed by aligned circumferential grooves formed on an exterior surface of a pipe and an interior surface of a sleeve. The at least part-circular interior and/or exterior surface (20, 24) may aid the formation of a seal and/or aid distribution of forces between the pipe and sleeve, in use.

### DESCRIPTION:

This invention relates to pipe couplings, and in particular to connectors suitable for use in sleeved pipe couplings.

Certain types of pipe couplings comprise a sleeve into which the ends of a pair of pipes to be coupled are inserted. Sleeved pipe couplings are available in a variety of forms and it is known to glue, weld or screw the ends of the pipes to be coupled into the sleeve to form the connection. It is also known to form a circumferential groove on the exterior surface of each pipe and a complementary circumferential groove on the interior surface of the sleeve. By such means, the pipe can be inserted axially into the sleeve and moved to a position in which the external groove of the pipe is aligned with the internal groove of the sleeve. Then, a connector can be fed, via a channel, into the annular gap formed by the respective grooves to form a connection. The engagement of the connector with the groove of the pipe and sleeve inhibits or prevents axial displacement of the pipe relative to the sleeve.

In certain case, the connector can be resiliently deformable, or coated with a sealant, so as to form a seal as well. An example of a sleeve pipe coupling of this general type is described in published European patent number 2350514.

Known connectors for couplings of the type described above are generally formed of this type are formed from a length of resilient material, which is able to take up the shape of the annular gap as the connector is slid, via the channel, into it. For example, the connector may be formed from a length of metal, such as a bar of spring steel or a length of metal wire. In addition, the connector may be covered with a lubricating coating, such as PTFE, to aid the movement of the connector through the annular gap.

However, in many cases, known sleeved pipe couplings are not suitable for use in hydraulic applications as they are not able to withstand high forces and/or cyclic loading.

This invention aims to provide a solution to the above problem, and/or to address one or more shortcomings associated with known connectors, and/or to provide an alternative connector suitable for use in a sleeved pipe coupling.

Various aspects of the invention are set forth in the following description and/or in the appendent claims.

The provision of an at least part-circular interior and/or exterior surface may aid the formation of a seal, in use, between an exterior surface of a cylindrical pipe and/or an interior surface of a tubular sleeve, respectively. The provision of an at least part-circular interior and/or exterior surface may aid the distribution of forces, in use, to an exterior surface of a cylindrical pipe and/or an interior surface of a tubular sleeve, respectively.

Suitably, the connector may be of unitary construction, that is to say, in which the at least some of the plurality of sub-units are integrally formed with adjacent sub-units.

Additionally or alternatively, the connector may comprise a hingedly interconnected construction, that is to say, in which the at least some of the plurality of sub-units are hingedly connected to adjacent sub-units.

The connector comprises a support wire, disposed radially outwardly, in use, of the sub-units. Suitably, the support wire, where provided, is located within a groove of the sub-units, which groove is located radially outwardly, in use, of the sub-units.

In a preferred embodiment of the invention, the shape of at least some of the sub units is substantially an annular sector prism, that is to say comprising either: a substantially flat base wall and side walls tapering inwardly from the base to a concave upper wall; or a convex base wall and side walls tapering inwardly from the base to a concave upper wall. Suitably, the concave upper wall is part cylindrical such that it substantially matches the profile of a portion of a part of a cylindrical surface to which it abuts, in use.

Suitably, the taper angle is selected such that, when the connector is bent into a loop, the side walls meet and the concave upper wall portions of the sub-units abut edge-to-edge to form a substantially continuous, part-cylindrical surface.

Suitably, the cross-sectional shape of each sub-unit (i.e. transverse to the longitudinal axis of the connector) is square or rectangular. This provides an advantage over wire (circular cross-sectioned connectors) inasmuch as axial loads can be borne perpendicularly on the surfaces of the sub-units.

The main body can be manufactured from any suitably material, but stainless steel (e.g. 316 stainless) may be preferred in certain applications.

Advantages of the invention may include: an increased (e.g. up to 200% more) bearing area than known connectors of this type (e.g. the “Staplelock” ™ connector); and up to 360-degree, 100% contact area within the groove of a sleeved pipe coupling.

Embodiments of the invention shall now be described, by way of example only, with reference to the accompanying drawings in which:

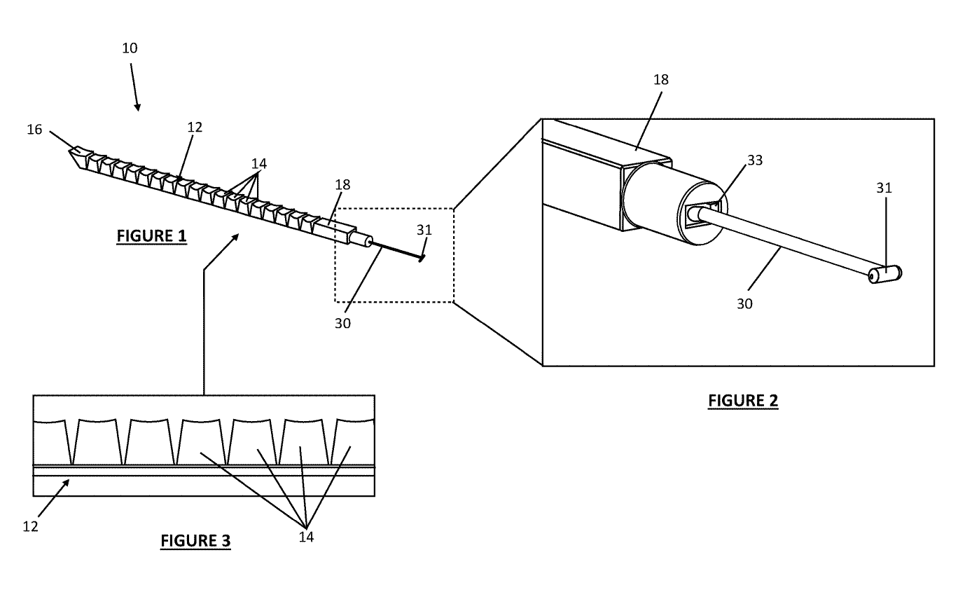

FIG. 1 is a perspective view of a connector in accordance with the invention;

FIG. 2 is a detail perspective view of the end of the connector of FIG. 1;

FIG. 3 is a schematic side view of a portion of the connector of FIG. 1;

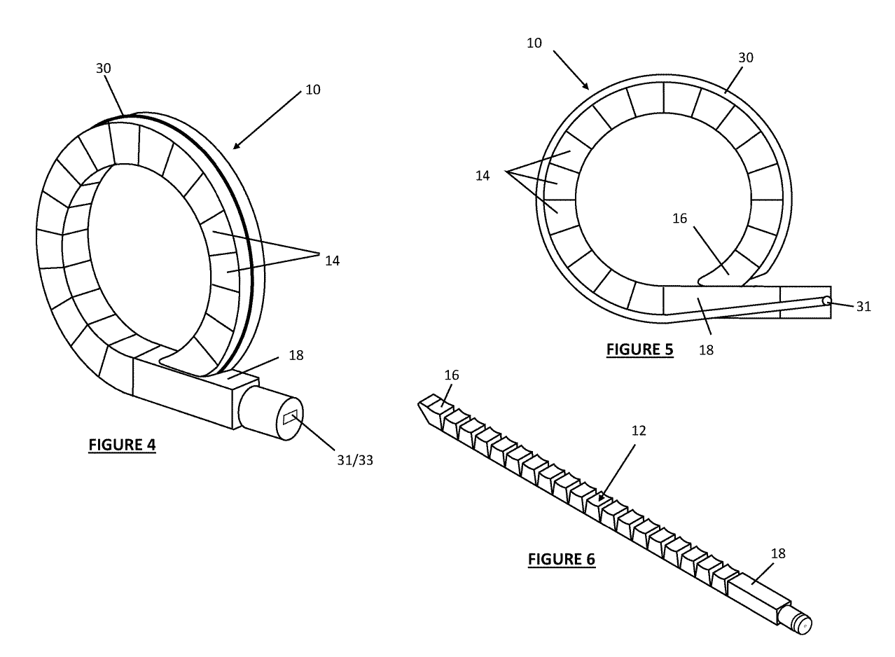

FIG. 4 is a perspective view of the connector of FIG. 1 in a rolled-up configuration;

FIG. 5 is a schematic cross-section of FIG. 4;

FIG. 6 is a perspective view of the main body of the connector of FIG. 1;

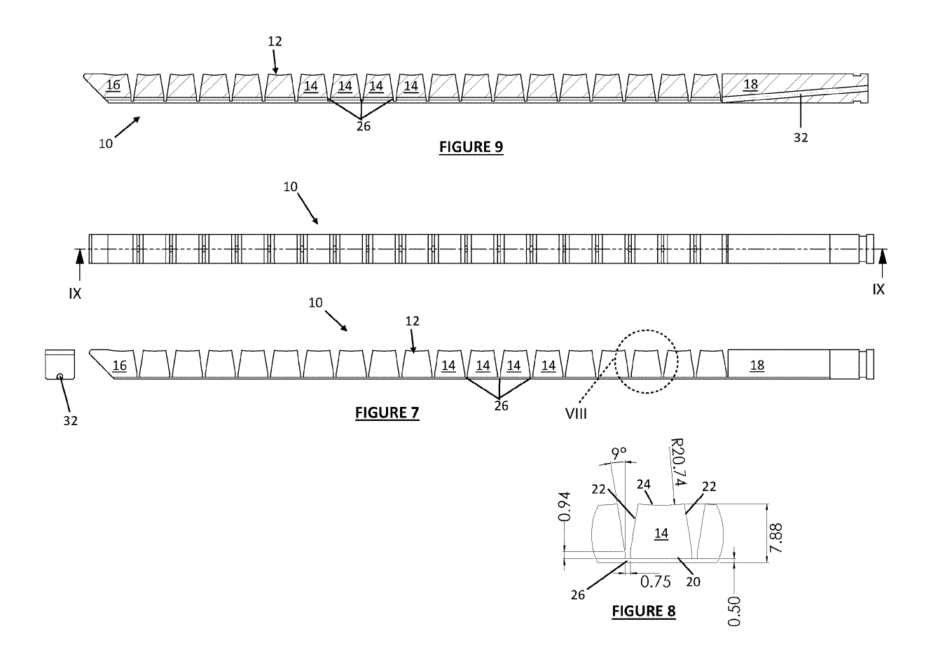

FIG. 7 is an orthographic projection of FIG. 5;

FIG. 8 is a detailed view of FIG. 7; and

FIG. 9 is a cross-section of FIG. 7 on IX-IX.

In the drawings, a connector 10 comprises a main body portion 12 formed from a plurality of integrally-formed sub-units 14. The connector 10 has a leading end 16 and a trailing end 18 formed by respective end blocks that are integrally formed with the sub-units 14.

The connector 10 can be laid flat, as shown in FIGS. 1, 6, 7 and 9 of the drawings, or it can be rolled-up, as it would be, in use, when installed in a pipe coupling (not shown), as shown in FIGS. 4 and 5 of the drawings.

Referring in particular to FIG. 8 of the drawings, each sub-unit 14 is substantially annular-sector-prism-shaped having a substantially flat base wall 20 and side walls 22 tapering inwardly from the base 20 to a concave upper wall 24. As can be seen from FIG. 8, the taper angle is 9 degrees meaning that the 19 sub-units 14 shown in FIG. 7, along with the leading end block 16 can be bent through 20×18 degrees, thus making up a complete circle, as shown in FIGS. 4 and 5 of the drawings.

The sub-units 14 are interconnected, in the illustrated embodiment, by a thin web 26 of material formed by notching a solid bar down to leave a thin interconnecting web 28 having a thickness of 0.5 mm, (but this measurement may be dictated in part, or entirely, by the other measurements of the connector, such as its radius of curvature, the outer diameter of the coupling, etc.), as shown in FIG. 8. This is, of course, just one possible embodiment of the invention and it will be appreciated that alternative manufacturing techniques may be employed, such as casting, forging etc., to obtain the desired shape and/or configuration. Further, in other embodiments of the invention, the individual sub-units 14 may be formed separately and bonded (e.g. by welding) to a support strip, which is the web 28 shown in the drawings. Other alternative and/or equivalent manufacturing techniques will be readily apparent to the skilled person.

Also visible in FIGS. 1 and 2 of the drawings is an internal wire 30, which locates within a through hole 32 extending longitudinally through the main body 12 along its base (outer surface, when rolled-up). The wire 30 terminates in a T-shaped end 31, to which an insertion/withdrawal tool (not shown) can be affixed to facilitate inserting or withdrawing the connector 10 from a sleeved pipe coupling, in use.

The main body 12 is manufactured out of a single bar of 316 stainless steel leaving a small piece in between each sub-unit 14 block to act as a hinge. The internal wire or cable 30 runs around the outside surface of the sub-units 14 in the channel 32, groove or longitudinal through hole, to keep the sub-units in position. The trailing end block 18 is welded to the end of the cable 30 and the cable 30 finished with a T joint 31.

In use, the connector 10 is inserted into a groove 32 that fits the profile of the blocks and cable. As the sub-units are pushed in around the inner diameter of a pipe coupling, the joint between each sub-unit bends allowing the side walls 22 to meet up and form a complete circular bar, which matches the groove of the sleeved pipe coupling. Whilst the connector 10 is being pushed-in, the cable around the outside, slides through the first sub-unit, until the blocks are in their final position and the T section 31 at the end of the cable 30 fits into a slot 33. If the T-section is not in the slot, the operator knows that the connector 10 is not fully installed. The leading end block 16 meets back around and can connect to the sub-unit to form a complete circumference. The inside of the sub-units are each part-circular, meaning that the connector 10 creates a tight flush finish again the outside diameter of the pipe.

When being removed, the operator simply pulls out the connector. If the connector 10 is too difficult to remove by hand, the operator can use a simple leverage tool and hooks onto the T section to pull it out. The T section can be coloured to show what size the connector is or to show if the wire hasn't been fully inserted.

The foregoing embodiments are merely exemplary of the invention and any shapes, sizes, configurations, materials etc. are illustrative only, and are not limiting on the invention.

The following statements are not the claims, but relate to various embodiments of the invention:
Statement 1. A connector comprising an elongate main body comprising a plurality of interconnected sub-units, wherein the sub-units are shaped such that the connector can be bent to form a loop having an at least part-circular interior or exterior surface.
Statement 2. A connector comprising an elongate main body comprising a plurality of interconnected sub-units, wherein the sub-units are shaped such that the connector can be bent to form a loop having an at least part-circular exterior surface and an at least part-circular interior surface.
Statement 3. The connector of statement 1 or statement 2, wherein the sub-units are hingedly interconnected.
Statement 4. The connector of statement 1, 2 or 3, of unitary construction.
Statement 5. The connector of statement 4, wherein at least some of the plurality of sub-units are integrally formed with adjacent sub-units.
Statement 6. The connector of any preceding statement, wherein the sub-units are interconnected by a thin web of material.
Statement 7. The connector of statement 6, wherein the thin web of material is formed by notching a solid bar to leave a thin interconnecting web between adjacent sub-units thereby formed.
Statement 8. The connector of statement 7, wherein individual sub-units are formed separately and bonded to a support web strip.
Statement 9. The connector of statement 8, wherein the bond comprises a weld.
Statement 10. The connector of statements 1, 2 or 3, comprising a support wire located radially outwardly, in use, of the sub-units.
Statement 11. The connector of statement 10, wherein the support wire is located within a groove of the sub-units, which groove is located radially outwardly, in use, of the sub-units.
Statement 12. The connector of statement 10, wherein the support wire locates within a through hole extending longitudinally through a radially outer part of the main body.
Statement 13. The connector of statements 10, 11 or 12, wherein the support wire terminates in a T-shaped end piece.
Statement 14. The connector of any preceding statement, wherein the shape of at least some of the sub units comprises a substantially annular sector prism.
Statement 15. The connector of statement 9, wherein the shape of at least some of the sub units comprises a substantially flat base wall and side walls tapering inwardly from the base to a concave upper wall.
Statement 16. The connector of statement 9, wherein the shape of at least some of the sub units comprises a convex base wall and side walls tapering inwardly from the base to a concave upper wall.
Statement 17. The connector of statement 11, wherein the concave upper wall is part cylindrical such that, in use, it substantially matches the profile of a portion of a part of a cylindrical surface to which it abuts.
Statement 18. The connector of statement 11 or statement 12, wherein the taper angle is selected such that, when the connector is bent into a loop, the side walls meet and the concave upper wall portions of the sub-units abut edge-to-edge to form a substantially continuous, part-cylindrical surface.
Statement 19. The connector of any preceding statement, wherein the main body is manufactured from stainless steel.
Statement 20. The connector of any preceding statement, comprising a leading end and a trailing end formed by respective end blocks that are integrally formed with the sub-units.
Statement 21. The connector of statement 20, wherein the leading end block is tapered such that when the connector is rolled up to form a loop, the leading end block seats on the trailing end block to form a complete circumference.
Statement 22. The connector of any preceding statement, wherein the cross-sectional shape of each sub-unit is square or rectangular.

1. A connector comprising an elongate main body comprising a plurality of interconnected sub-units, wherein the sub-units are shaped such that the connector can be bent to form a loop having an at least part-circular interior and/or exterior surface, the shape of at least some of the sub-units comprising a substantially annular sector prism, and wherein the sub-units are interconnected by bonding them to a support strip located radially outwardly, in use, of the sub-units.

2-22. (canceled)

23. The connector of claim 1 wherein individual sub-units are formed separately and bonded to the support strip.

24. The connector of claim 1 wherein the bond comprises a weld.

25. The connector of claim 1, wherein the support strip comprises a support wire.

26. The connector of claim 25, wherein the support wire is located within a groove of the sub-units, which groove is located radially outwardly, in use, of the sub-units.

27. The connector of claim 25, wherein the support wire terminates in a T-shaped end piece.

28. The connector of claim 1, wherein the shape of at least some of the sub-units having the substantially annular sector prism shape comprise a substantially flat base wall and side walls tapering inwardly from the base wall to a concave upper wall.

29. The connector of claim 28, wherein the concave upper wall is part cylindrical such that, in use, it substantially matches a profile of a portion of a part of a cylindrical surface to which it abuts.

30. The connector of claim 28, wherein a taper angle is selected such that, when the connector is bent into a loop, the side walls meet and the concave upper wall portions of the sub-units abut edge-to-edge to form a substantially continuous, part-cylindrical surface.

31. The connector of claim 1, wherein the shape of at least some of the sub-units having a substantially annular sector prism shape comprise a convex base wall and side walls tapering inwardly from the base to a concave upper wall.

32. The connector of claim 30, wherein the concave upper wall is part cylindrical such that, in use, it substantially matches a profile of a portion of a part of a cylindrical surface to which it abuts.

33. The connector of claim 31, wherein the taper angle is selected such that, when the connector is bent into a loop, the side walls meet and the concave upper wall portions of the sub-units abut edge-to-edge to form a substantially continuous, part-cylindrical surface.

34. The connector of claim 1, wherein the main body is manufactured from stainless steel.

35. The connector of claim 1, comprising a leading end and a trailing end formed by respective end blocks that are integrally formed with the sub-units, the leading end block being tapered such that when the connector is rolled up to form a loop, the leading end block seats on the trailing end block to form a complete circumference.

36. The connector of claim 1, wherein the cross-sectional shape of each sub-unit is square or rectangular.

37. The connector of claim 1, wherein at least some of the plurality of sub-units are integrally formed with adjacent sub-units and are interconnected by a thin web of material which is formed by notching a solid bar to leave a thin interconnecting web between adjacent sub-units thereby formed.
